(19) United States
(12) Patent Application Publication
(10) Pub. No.: US 2022/0158198 A1
(43) Pub. Date: May 19, 2022

(54) SOLID-STATE BATTERY

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/455,017

(22) Filed: Nov. 16, 2021

(30) Foreign Application Priority Data
Nov. 19, 2020 (JP) 2020-192474

(51) Int. Cl. H01M 4/78; H01M 4/13; H01M 50/107; H01M 10/058; H01M 50/186; H01M 4/66

(52) U.S. Cl. CPC H01M 4/78; H01M 4/13; H01M 50/107; H01M 2300/0065; H01M 50/186; H01M 4/661; H01M 10/058

(57) ABSTRACT

To provide a solid-state battery capable of achieving a higher capacity. A solid-state battery includes a positive electrode and a negative electrode. The positive electrode and the negative electrode each includes a current collector that is a metal porous body having a spiral shape, and an electrode material mixture with which the current collector is filled. The positive electrode and the negative electrode are arranged in combination such that opposing faces of the positive electrode and the negative electrode alternately contact each other in an axial direction of the spiral shape. A pair of the positive electrode and the negative electrode having the above structure are housed in an exterior packaging body having a cylindrical shape to achieve a higher capacity of the solid-state battery.

This application is based on and claims the benefit of priority from Japanese Patent Application No. 2020-192474, filed on 19 Nov. 2020, the content of which is incorporated herein by reference.

### BACKGROUND OF THE INVENTION

### Field of the Invention

The present invention relates to a solid-state battery.

### Related Art

Conventionally, lithium ion secondary batteries are widely used as secondary batteries having a high energy density. A lithium ion secondary battery is configured to include a positive electrode, a negative electrode, and a separator interposed therebetween, and to be filled with a liquid electrolyte.

In this regard, since the electrolytic solution of such a lithium ion secondary battery is usually a flammable organic solvent, some lithium ion secondary batteries pose a safety issue when exposed to heat, in particular. Therefore, solid-state batteries employing an inorganic solid electrolyte as an alternative to the organic liquid electrolyte have been proposed (see Patent Document 1).
Patent Document 1: Japanese Unexamined Patent Application, Publication No. 2000-106154

### SUMMARY OF THE INVENTION

With respect to a conventional secondary battery such as a lithium-ion secondary battery with a liquid electrolyte, a large capacity battery cell having a cylindrical shape can be fabricated by laminating and winding a pair of electrodes, which are a positive electrode and a negative electrode each coated with an active material, and filling the inside of the resulting cylindrical wound body with an electrolytic solution.

A solid-state battery housed in an exterior packaging body having a cylindrical shape has an advantage over a solid-state battery housed in an exterior packaging body having a square tubular shape, for example, in that stress is not concentrated at corners and thus restraining pressure can be applied uniformly. In the case of a solid-state battery, it is difficult to fabricate a wound body because the electrodes are hard and brittle, and thus it is conceivable that a battery cell is composed of a laminated body in which a plurality of electrodes are laminated. However, when the above-mentioned laminated body is housed in an exterior packaging body having a cylindrical shape, it is not possible to take a structure that puts out tabs for parallel connection to the electrodes, and thus a series connection structure has to be taken. This results in a high voltage and small capacity cell, which requires an insulating component for the high voltage. In addition, when a plurality of cells are connected in parallel to achieve a higher capacity, it is necessary to install as many contactors and the like as the number of the cells connected in parallel. Therefore, the number of components increases, and thus the energy density of each module decreases.

In response to the above issue, it is an object of the present invention to provide a solid-state battery capable of achieving a higher capacity.

(1) A first aspect of the present invention relates to a solid-state battery including a positive electrode and a negative electrode. The positive electrode and the negative electrode each include a current collector that is a metal porous body having a spiral shape, and an electrode material mixture with which the current collector is filled. The positive electrode and the negative electrode are arranged in combination such that opposing faces of the positive electrode and the negative electrode alternately contact each other in an axial direction of the spiral shape.

According to the invention of the first aspect, it is possible to provide a solid-state battery capable of achieving a higher capacity.

(2) In a second aspect of the present invention according to the first aspect, the positive electrode and the negative electrode are housed in an exterior packaging body having a cylindrical shape.

According to the invention of the second aspect, uniform restraining pressure can be applied to the positive electrode and the negative electrode, which can improve the battery performance as well as the energy density when the solid-state battery is modularized.

(3) In a third aspect of the present invention according to the first or second aspect, at least one of the positive electrode or the negative electrode has a surface on which a solid electrolyte layer is formed.

According to the invention of the third aspect, it is possible to prevent a short circuit caused by contact between the electrodes or contact between the electrode and the exterior packaging body.

(4) In a fourth aspect of the present invention according to the second or third aspect, the solid-state battery includes sealing members that seal both ends in an axial direction of the exterior packaging body having the cylindrical shape. The positive electrode and the negative electrode are sealed inside the exterior packaging body having the cylindrical shape by being pressed from the axial direction through the sealing members.

According to the invention of the fourth aspect, uniform restraining pressure can be applied to the positive electrode and the negative electrode, and the battery performance can be improved.

### BRIEF DESCRIPTION OF THE DRAWINGS

FIG. 1 is a perspective view of a solid-state battery according to an embodiment of the present invention;

FIG. 2A is a diagram showing a method for manufacturing an electrode for the solid-state battery according to the embodiment of the present invention;

FIG. 2B is a diagram showing the method for manufacturing the electrode for the solid-state battery according to the embodiment of the present invention; and

FIG. 2C is a diagram showing the method for manufacturing the electrode for the solid-state battery according to the embodiment of the present invention.

### DETAILED DESCRIPTION OF THE INVENTION

An embodiment of the present invention will now be described with reference to the drawings. However, the following embodiment exemplifies the present invention, and the present invention is not limited to the following embodiment.

### <Solid-State Battery>

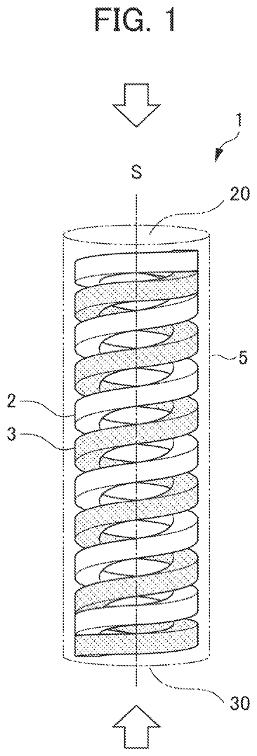

As shown in FIG. 1, a solid-state battery 1 according to the present embodiment includes a pair of a positive electrode 2 and a negative electrode 3 each having a spiral shape, and an exterior packaging body 5 having a cylindrical shape.

### (Positive Electrode and Negative Electrode)

As shown in FIG. 1, the pair of the positive electrode 2 and the negative electrode 3 each having the spiral shape, which are electrodes for the solid-state battery according to this embodiment, are arranged in combination so that opposing faces of the electrodes alternately contact each other in the axial direction of the spiral shape. The above structure enables the pair of electrodes of the solid-state battery to be housed inside the exterior packaging body having the cylindrical shape, and also enables a large surface area of the pair of electrode layers to be provided, so that a higher capacity of the solid-state battery 1 can be achieved.

The spiral shapes of the positive electrode 2 and the negative electrode 3 are not limited as long as they can be arranged in combination so that opposing faces of the electrodes alternately contact each other in the axial direction of the spiral shape and they are in accordance with the shape of the exterior packaging body 5. For example, the positive electrode 2 and the negative electrode 3 may have the same spiral shape. The faces of the electrodes facing each other in the axial direction of the spiral shape may be optionally inclined. As shown in FIG. 1, the axial center portion of the spiral shape may have a void, but does not have to have a void as long as the spiral shapes can be alternately superposed on each other.

### (Current Collector)

The current collectors each constituting the positive electrode 2 and the negative electrode 3 are each composed of a metal porous body. The metal porous body has pores that are continuous with each other, and the pores can be filled with an electrode material mixture including an electrode active material. The form of the metal porous body is not limited as long as it has pores that are continuous with each other. Examples of the form of the metal porous body include a foam metal having pores by foaming, a metal mesh, an expanded metal, a punching metal, and a metal nonwoven fabric. The metal used in the metal porous body is not limited as long as it has electric conductivity. Examples thereof include nickel, aluminum, stainless steel, titanium, copper, and silver. Among these, as the current collector constituting the positive electrode, a foamed aluminum, foamed nickel, and foamed stainless steel are preferable. As the current collector constituting the negative electrode, a foamed copper and foamed stainless steel are preferable.

The current collector, which is a metal porous body, has pores that are continuous with each other inside, and has a larger surface area than a conventional metal foil current collector. By using the above-described metal porous body as a current collector, the pores can be filled with an electrode material mixture including an electrode active material. This allows the amount of the active material per unit area of the electrode layer to be increased, and thus the volumetric energy density of the solid-state battery can be improved. In addition, since the electrode material mixture is easily fixed, it is not necessary to thicken a coating slurry for forming the electrode material mixture layer when a film of the electrode material mixture layer is thickened, unlike a conventional electrode using a metal foil as a current collector. Therefore, it is possible to reduce a binder such as an organic polymer compound that has been necessary for thickening. Accordingly, the capacity per unit area of the electrode can be increased, and a higher capacity of the solid-state battery can be achieved.

### [Electrode Material Mixture]

The electrode material mixtures, with which the current collectors each constituting the positive electrode 2 and the negative electrode 3 are filled, each include at least an electrode active material. The electrode material mixture applicable to this embodiment may optionally include other components as long as an electrode active material is included as an essential component. The other components are not limited, and may be any components that can be used in making a solid-state battery. Examples of the other components include a solid electrolyte, a conductivity aid, and a binder.

The positive electrode material mixture constituting the positive electrode 2 contains at least a positive electrode active material, and may contain other components, such as a solid electrolyte, a conductivity aid, and a binder. The positive electrode active material is not limited as long as it can occlude and release lithium ions. Examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, Li(Ni_{1/3}Co_{1/3}Mn_{1/3})O₂, LiCoO₄, LiMn₂O₄, LiNiO₂, LiFePO₄, lithium sulfide, and sulfur.

The negative electrode material mixture constituting the negative electrode 3 contains at least a negative electrode active material, and may contain other components, such as a solid electrolyte, a conductivity aid, and a binder. The negative electrode active material is not limited as long as it can occlude and release lithium ions. Examples thereof include metallic lithium, lithium alloys, metal oxides, metal sulfides, metal nitrides, Si, SiO, and carbon materials such as artificial graphite, natural graphite, hard carbon, and soft carbon.

### [Solid Electrolyte]

A solid electrolyte layer is formed on the surface of at least one of the positive electrode 2 or the negative electrode 3. The solid electrolyte layer contains at least a solid electrolyte material. Charge transfer between the positive electrode active material and the negative electrode active material can be performed through the above solid electrolyte material. The formation of the solid electrolyte layer on the electrode surface can prevent a short circuit due to contact between the exterior packaging body 5 and the conductive portion of the electrode. Since the metal porous bodies each constituting the positive electrode 2 and the negative electrode 3 have a plurality of pores provided therewithin, a concave-convex shape is formed on the surface of the metal porous body when the metal porous body is cut into a predetermined shape. As a result, when stress is applied to the positive electrode 2 and the negative electrode 3 from the outside, the stress concentrates on the convex part, which may cause the convex part to contact the conductive portion of the other electrode, resulting in a short circuit. However, the formation of the solid electrolyte layer on the electrode surface can prevent the above short circuit. In view of the above, it is preferable that the solid electrolyte layer is formed over the entire electrode surface, not only on the faces of the positive electrode 2 and the negative electrode 3 facing each other in the axial direction of the spiral shape, which are the faces on which the positive electrode 2 and the negative electrode 3 contact each other. Further, it is preferable that the solid electrolyte layer is formed on both the positive electrode 2 and the negative electrode 3.

The solid electrolyte is not limited, and any known solid electrolyte that can be used in a solid-state battery can be used. Examples of the solid electrolyte include a sulfide solid electrolyte material, an oxide solid electrolyte material, a nitride solid electrolyte material, and a halide solid electrolyte material.

### [Exterior Packaging Body]

The exterior packaging body 5 houses the positive electrode 2 and the negative electrode 3, and has a cylindrical shape. The exterior packaging body 5 includes a lid 20 and a lid 30, which are sealing members that seal both ends of the exterior packaging body 5 in the axial direction. The material of the exterior packaging body 5 is not limited, and for example, a metallic material can be used. By using a metallic material as the material of the exterior packaging body 5, strong restraining pressure can be applied to the positive electrode 2 and the negative electrode 3. The metallic material is not limited as long as it can be used as an exterior packaging body of a battery. Examples thereof include aluminum and stainless steel. Alternatively, as the material of the exterior packaging body 5, a resin such as a synthetic resin can be used.

The lid 20 and the lid 30 are not limited as long as they can seal both ends of the exterior packaging body 5 in the axial direction. It is preferable that the lid 20 and the lid 30 each have, for example, a disk shape, are electrically connected to an end of the positive electrode 2 and an end of the negative electrode 3, respectively, and each also function as a current collecting plate of the solid-state battery 1. When the lid 20 and the lid 30 each also function as a current collecting plate, the lid 20 and the lid 30 are preferably each composed of a current-carrying material.

As shown by arrows in FIG. 1, the lid 20 and the lid 30 are configured to be movable from the outside in the direction of an axis S of the exterior packaging body 5 having the cylindrical shape toward the central portion of the solid-state battery 1. By respectively moving the lid 20 and the lid 30 in the directions of the arrows in FIG. 1, the positive electrode 2 and the negative electrode 3 are pressed through the lid 20 and the lid 30, and thus restraining pressure can be applied to the positive electrode 2 and the negative electrode 3. Since the exterior packaging body 5 has a cylindrical shape, and restraining pressure is applied from the axial direction, uniform restraining pressure can be applied to the end of the positive electrode 2 and the end of the negative electrode 3, which respectively contact the lid 20 and the lid 30. Therefore, even when the solid-state battery 1 is modularized, a high restraining component is not required, and thus the energy density of each module can be improved. Further, uniform restraining pressure can be applied to the side face portions of the positive electrode 2 and the negative electrode 3 that contact the inner peripheral face of the exterior packaging body 5. By applying the uniform restraining pressure as described above, the internal resistance of the solid-state battery 1 can be made uniform, and as a result, the reaction rate of the battery reaction occurring inside the solid-state battery 1 can be made uniform. Accordingly, a desirable battery performance can be achieved. Further, by restraining the side face portions of the positive electrode 2 and the negative electrode 3, when the solid-state battery 1 is used for automotive use, it is possible to prevent the superposed electrodes from becoming displaced due to vibration and collision when the battery is mounted in an automobile, and to suppress damage or the like to the superposed body. Accordingly, high durability and high safety of the solid-state battery 1 can be achieved.

### <Method for Manufacturing Solid-State Battery>

A method for manufacturing the solid-state battery 1 according to the present embodiment includes a filling step of filling a metal porous body with an electrode material mixture, a cutting step of cutting the metal porous body into a spiral shape, a solid electrolyte layer forming step of forming a solid electrolyte layer on the surface of the electrode, and a housing step of superposing the spiral shapes of the positive electrode 2 and the negative electrode 3 on each other alternately and housing the electrodes inside the exterior packaging body 5.

The method for manufacturing the solid-state battery according to this embodiment is described below using the positive electrode 2 as an example, with reference to the drawings. The same manufacturing method can be applied to the negative electrode 3.

### (Filling Step)

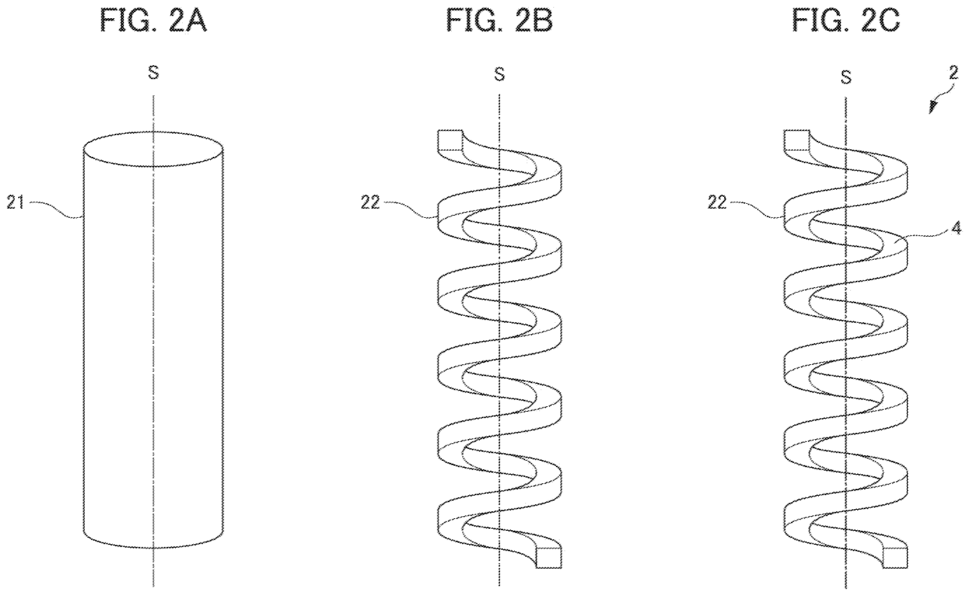

As shown in FIG. 2A, the filling step is a step of impregnating the pores of a metal porous body 21 having a cylindrical shape with an electrode material mixture including an electrode active material. The method of filling the metal porous body 21 with the electrode material mixture is not limited. Examples thereof include a method of filling the pores of the metal porous body 21 with a slurry including the electrode material mixture by applying pressure using a plunger-type die coater. Alternatively, the inside of the metal porous body may be impregnated with an ion conductor layer by a dipping method.

### (Cutting Step)

As shown in FIG. 2B, the cutting step is a step in which the metal porous body 21 having the cylindrical shape, which has been filled with the electrode material mixture inside in the filling step, is cut so as to have a spiral shape 22. The above cutting step is not limited. After hollowing out in advance an axial center S of the metal porous body 21 having the cylindrical shape as shown in FIG. 2A, the metal porous body 21 may be cut so as to have the spiral shape 22. Alternatively, the metal porous body 21 having the cylindrical shape may be cut so as to have the spiral shape without hollowing out the axial center S of the metal porous body 21.

### (Solid Electrolyte Layer Forming Step)

As shown in FIG. 2C, the solid electrolyte layer forming step is a step of forming a solid electrolyte layer 4 on the surface of the metal porous body that has been cut so as to have the spiral shape 22. The method of forming the solid electrolyte layer 4 is not limited, and for example, a dipping method of dipping the metal porous body having the spiral shape 22 into a slurry containing a solid electrolyte can be used.

### (Housing Step)

As shown in FIG. 1, the housing step is a step of arranging the positive electrode 2 and the negative electrode 3 so that opposing faces of the electrodes alternately contact each other in the axial direction of the spiral shape, and housing the arranged electrodes in the exterior packaging body 5 having the cylindrical shape. After the positive electrode 2 and the negative electrode 3 are housed in the exterior packaging body 5, the lid 20 and the lid 30 are attached to the exterior packaging body 5, and then appropriate restraining pressure is applied from above and below of the exterior packaging body 5 in the axial direction. Accordingly, the solid-state battery 1 can be manufactured.

The method for manufacturing the solid-state battery 1 according to the embodiment described above is illustrated only as an example, and the solid-state battery 1 may be manufactured by a method other than that described above. For example, the above filling step may be provided after the above cutting step.

A preferred embodiment of the present invention has been described above, but the content of the present invention is not limited to the above embodiment and can be modified as appropriate.

### EXPLANATION OF REFERENCE NUMERALS

1 solid-state battery
2 positive electrode
3 negative electrode
4 solid electrolyte layer
5 exterior packaging body
20, 30 lid (sealing member)

What is claimed is:

1. A solid-state battery comprising a positive electrode and a negative electrode,
the positive electrode and the negative electrode each comprising: a current collector that is a metal porous body having a spiral shape; and an electrode material mixture with which the current collector is filled,
the positive electrode and the negative electrode being arranged in combination such that opposing faces of the positive electrode and the negative electrode alternately contact each other in an axial direction of the spiral shape.

2. The solid-state battery according to claim 1, wherein the positive electrode and the negative electrode are housed in an exterior packaging body having a cylindrical shape.

3. The solid-state battery according to claim 1, wherein at least one of the positive electrode or the negative electrode has a surface on which a solid electrolyte layer is formed.

4. The solid-state battery according to claim 2,
wherein the solid-state battery comprises sealing members that seal both ends in an axial direction of the exterior packaging body having the cylindrical shape, and
wherein the positive electrode and the negative electrode are sealed inside the exterior packaging body having the cylindrical shape by being pressed from the axial direction through the sealing members.
